(19) United States
(12) Patent Application Publication
(10) Pub. No.: US 2018/0335900 A1
(43) Pub. Date: Nov. 22, 2018

(54) DYNAMIC SUPPORT FEEDBACK FOR IN-APP HELP

(71) Applicant: Microsoft Technology Licensing, LLC, Redmond, WA (US)

(72) Inventors: Vadivelan Ramalingam, Redmond, WA (US); Donovan Allen Isaak, Kenmore, WA (US); Chun Hin Nelson Siu, Kirkland, WA (US); Esha Sharma, Redmond, WA (US)

(21) Appl. No.: 15/601,246

(22) Filed: May 22, 2017

(51) Int. Cl. G06F 3/0482; G06N 99/00; G06F 3/0484

(52) U.S. Cl. CPC G06F 3/0482; G06F 3/04845; G06N 99/005

(57) ABSTRACT

Aspects of the present disclosure relate to systems and methods for dynamically updating in-app help to reflect help content associated with submitted issues. In one aspect, submitted issues data categorized by issue topics associated with a service is received. An active summary of the submitted issues data is generated for presentation in a control panel. The active summary may indicate at least one issue topic category having a highest number of submitted issues within a time span. Help content associated with the at least one issue topic category having the highest number of submitted issues within the time span may be sent to the service for updating an in-app help pane of an application associated with the service to reflect the help content.

### BACKGROUND

Computer and software users have grown accustomed to user-friendly software applications for co-authoring files, documents, messages, and the like. For example, storage providers (e.g., cloud storage providers) provide applications where users can co-author and collaborate with one another within the applications. In this regard, users may contact the storage provider for support when they encounter an issue and/or problem with the service. In some cases, in-app help may provide answers to commonly asked questions. Current techniques for providing answers to reported issues and/or problems include support personal manually reviewing issued tickets to determine what issues with the service are arising and require answers. However, when a substantial number of issue tickets are submitted, manually reviewing the issued tickets may lead to undetected issues, a lack in providing answers to issues, and/or a slow response time to submitted issues, ultimately leading to frustration among users/customers of the service, lower quality services, and substantial resources for providing support.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In summary, the disclosure generally relates to systems and methods for dynamically updating in-app help to reflect help content associated with submitted issues. In one aspect, submitted issues data categorized by issue topics associated with a service is received. An active summary of the submitted issues data is generated for presentation in a control panel. The active summary may indicate at least one issue topic category having a highest number of submitted issues within a time span. Help content associated with the at least one issue topic category having the highest number of submitted issues within the time span may be sent to the service for updating an in-app help pane of an application associated with the service to reflect the help content.

In another aspect, a method for dynamically updating in-app help to reflect help content associated with submitted issues is presented. In one example, submitted issues data categorized by issue topics associated with a service may be received. An active summary of the submitted issues data may be generated for presentation in a control panel. The active summary indicates at least one issue topic category having a spike in submitted issues within a time span. Help content associated with the at least one issue topic category having the spike in submitted issues within the time span may be sent to the service for updating an in-app help pane of an application associated with the service to reflect the help content.

In yet another aspect, an application associated with a service may include an issue reporting panel through which to submit an issue associated with the service, a first version of an in-app help pane through which to display help content for issue topics associated with the service in a user interface to the application, and a second version of the in-app help pane through which to, in response to receiving help content associated with at least one of the issue topics having a highest number of submitted issues within a time span, display the help content in the user interface to the application, where an active summary of issue topic categories indicates the issue topics having the highest number of submitted issues within the time span.

### DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 illustrates an exemplary support feedback system for dynamically updating in-app help to reflect help content associated with submitted issues, according to an example aspect.

FIG. 2 illustrates an exemplary control panel including submitted issues data, according to an example aspect.

FIG. 3A illustrates one view of an application options panel, according to an example aspect.

FIG. 3B illustrates one view of an issue reporting panel, according to an example aspect.

FIG. 3C illustrates one view in the progression of views of an application, according to an example aspect.

FIG. 3D illustrates another view in the progression of views of the application of FIG. 3C, according to an example aspect.

FIG. 4 illustrates an exemplary method for dynamically updating in-app help to reflect help content associated with submitted issues, according to an example aspect.

FIG. 5 illustrates a computing system suitable for implementing the enhanced support feedback technology disclosed herein, including any of the environments, architectures, elements, processes, user interfaces, and operational scenarios and sequences illustrated in the Figures and discussed below in the Technical Disclosure.

### DETAILED DESCRIPTION

Aspects of the disclosure are generally directed to systems and methods for dynamically updating in-app help to reflect help content associated with submitted issues. For example, issues and/or problems associated with a service may be submitted by a user of the service. Tickets having submitted issues may be generated and stored in a database for storing the tickets. The submitted issues data may be processed by cognitive services, such as Azure, by applying a machine learning text classifier to the data. The processed data may be categorized by issue topics associated with the service. For example, a plurality of categories of issue topics may be created for the service. When the issues data is processed, text may be extracted from each ticket generated indicating a topic associated with the issue. The ticket and/or issue may then be placed in a category of issue topics (e.g., an issue topic category). In one example, the issue data categorized by issue topics may be sent to a data warehouse for processing. An active summary of the submitted issues data may be generated for presentation in a control panel, for example. In one example, the active summary includes data such as issue topic categories, a time scale associated with the issue topic categories, one or more submitted issue tickets, product version data, and one or more top issue topic categories (e.g., the category of issues having the most submitted issue tickets for a particular time frame).

In one example, a support administrator of the service may have access to the control panel to view the active summary. In response to receiving a selection of at least one of the issue topic categories, data associated with the selected issue topic category (e.g., a time scale of submitted issues and one or more submitted issue tickets) may be included in the active summary for presentation in the control panel. In this regard, changes and/or shifts in submitted issues may be quickly and easily detected. In one example, it is determined whether a current version of in-app help includes help content associated with the most frequently submitted issues. When the current version of the in-app help does not include help content associated with the most frequently submitted issues, the in-app help may be updated to reflect help content associated with the most frequently submitted issues. In some examples, when a new issue arises (e.g., a new issue associated with a new product and/or service), new help content may be created to address the new issue. The in-app help may be updated to reflect the new help content associated with a new issue. In some examples, quickly and easily detecting the most frequently submitted issue topics and/or categories may result in improved services and/or products. For example, when an issue is directed to a specific product and/or service, the product and/or service may be quickly evaluated, fixed and/or upgraded to solve the issue.

As discussed above, current techniques for providing answers to reported issues and/or problems include support personal manually reviewing issued tickets to determine what issues with the service are arising and require answers. However, when a substantial number of issue tickets are submitted, manually reviewing the issued tickets may lead to undetected issues, a lack in providing answers to issues, and/or a slow response time to submitted issues, ultimately leading to frustration among users/customers of the service, lower quality services, and substantial resources for providing support.

Accordingly, aspects described herein include tools and/or techniques for quickly detecting issues, quickly providing responses to issues, dynamically updating in-app help as issues are submitted, and providing higher quality products and services. In one aspect, submitted issues data categorized by issue topics associated with a service may be received. For example, the categorized issue topic data may be received at a data warehouse associated with the service. In one example, the data warehouse may be configured to store and process the received categorized issue topic data. In another example, the data warehouse may be configured to generate an active summary of the submitted issues data. In one example, the active summary is generated for presentation in a control panel. The control panel may facilitate viewing of the active summary. In one example, the active summary may indicate at least one issue topic category having a highest number of submitted issues within a time span. For example, one or more top issue topic categories including the number of submitted issues may be included in the active summary. In this regard, the issue topic categories having the highest number of submitted issues may be identified. A time scale associated with the issue topic categories having the highest number of submitted issues may be included in the active summary. For example, for a given issue topic category, the frequency of submitted issues may be viewed within a time span. In one example, the time span may include at least one of an hour, a day, a week, and a month. Help content associated with the at least one issue topic category having the highest number of submitted issues may be sent to the service for updating the in-app help pane of an application associated with the service to reflect the sent help content. In this regard, in-app help may be updated quickly and dynamically with help content to address issues as they are submitted and/or shortly after they are submitted.

In turn, a technical effect that may be appreciated is that the tools and/or techniques disclosed herein solve the problem of identifying issues associated with a service, providing help content for the issues, and improving the service and/or products associated with the service by providing a support feedback system that facilitates quick identification of service issues, quick help content responses to the services issues, and higher quality services and products. Another technical effect that may be appreciated is that the tools and/or techniques disclosed herein are directed to an improvement in the technical space of customer support and/or debugging technical issues associated with a service (e.g., a cloud service such as OneDrive). A further technical effect that may be appreciates is that user interaction with applications and/or the application services is improved by providing quick responses to submitted issues and/or updating in-app help with help content as and/or shortly after issues are submitted, ultimately improving user efficiency with the applications and/or services and increasing user interaction performance (e.g., a user can quickly identify and read help content associated with her issue such that the user may quickly resolve her issue and continue interacting with the application).

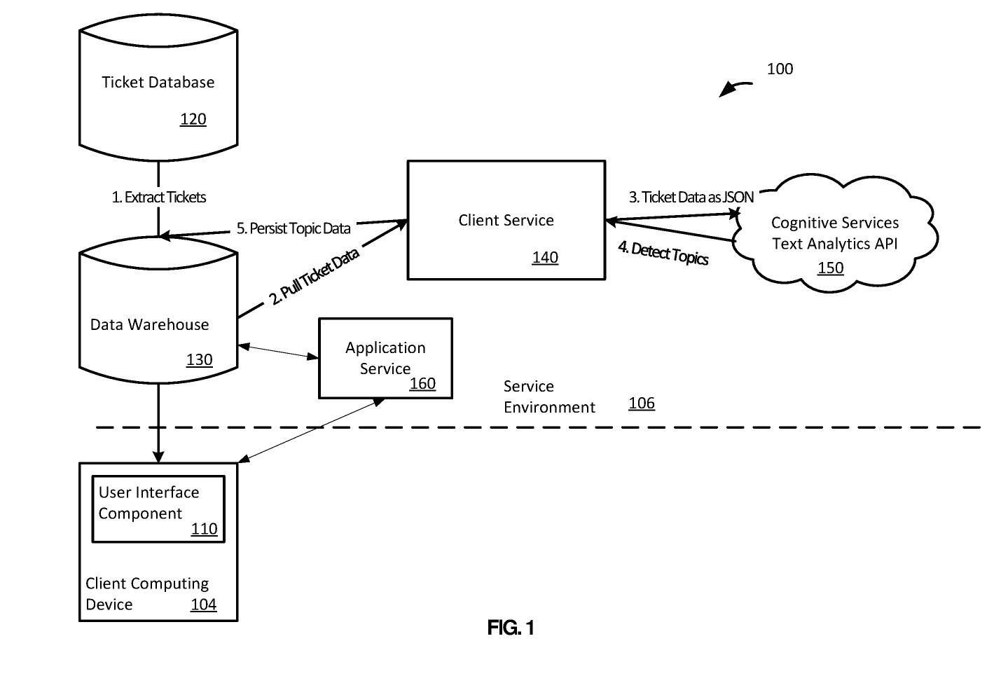

Referring now to the drawings, in which like numerals represent like elements through the several figures, aspects of the present disclosure and the exemplary operating environment will be described. With reference to FIG. 1, one aspect of a support feedback system 100 for dynamically updating in-app help to reflect help content associated with submitted issues is illustrated. In aspects, the support feedback system 100 may include client computing device 104 and a service environment 106. In a basic configuration, the client computing device 104 may be a handheld computer having both input elements and output elements. The client computing device 104 may be any suitable computing device for implementing the support feedback system 100 for dynamically updating in-app help to reflect help content associated with submitted issues. For example, the client computing device 104 may be at least one of: a mobile telephone; a smart phone; a tablet; a phablet; a smart watch; a wearable computer; a personal computer; a desktop computer; a laptop computer; a gaming device/computer (e.g., Xbox); a television; etc. This list is exemplary only and should not be considered as limiting. Any suitable client computing device 104 for implementing the support feedback system 100 for dynamically updating in-app help to reflect help content associated with submitted issues may be utilized.

In aspects, the service environment 106 may provide data to and from the client computing device 104 through a network. In aspects, the support feedback system 100 may be implemented in more than one service environment 106, such as a plurality of service environments 106. As discussed above, the service environment 106 may provide data to and from the client computing device 104 through a network. The data may be communicated over any network suitable to transmit data. In some aspects, the network is a distributed computer network such as the Internet. In this regard, the network may include a Local Area Network (LAN), a Wide Area Network (WAN), the Internet, wireless and wired transmission mediums. The data may be communicated in accordance with various communication protocols, combinations of protocols, or variations thereof. In one example, the data may be communicated in accordance with the HTTPS (Secure Hypertext Transfer Protocol).

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, the aspects and functionalities described herein may operate over distributed systems (e.g., cloud-based computing systems), where application functionality, memory, data storage and retrieval, and various processing functions may be operated remotely from each other over a distributed computing network, such as the Internet or an Intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which aspects of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As discussed above, the support feedback system 100 may include client computing device 104 and the service environment 106. The various components may be implemented using hardware, software, or a combination of hardware and software. The support feedback system 100 may be configured to dynamically update in-app help of an application to reflect help content associated with submitted issues of a service (e.g., application service 160). In one example, an application may include any application suitable for accessing and/or interacting with datasets (e.g., datasets stored at a service) such as collaboration applications, email applications, chat applications, voice applications, and the like. In one example, a collaboration application may include an application such as a OneDrive application and a SharePoint application. In another example, an application may include at least one of a mobile application, a sync client, and a web application. For example, a mobile application may include an application that is downloaded on a mobile device, for example. In this regard, the mobile application can include an application for a plurality of mobile device operating systems such as Windows®, Android®, iOS®, and the like. The sync client may be integrated with a file explorer of the client computing device 104 for accessing files stored on the client computing device 104 and/or a service (e.g., application service 160). The web application may include a website for accessing a service (e.g., using a browser to access the service via a website of the service).

As illustrated in FIG. 1, the service environment 106 includes a ticket database 120, a data warehouse 130, a client service 140, cognitive services 150, and application service 160. In one example, the ticket database 120 may be configured to store issue tickets submitted by users/customers of the applications service 160. For example, when a user of the service 160 submits an issue (e.g., reports a problem) associated with the service 160, an issue ticket may be created for the issue and stored in the ticket database 120. In one example, the service 160 may be a cloud storage service such as OneDrive, SharePoint, and the like. In this regard, a user may report a problem associated with the service 160 while using an application such as a OneDrive application and/or a SharePoint application. In one example, the submitted issue may be associated with the application used to engage and access the service 160 (e.g., a OneDrive application and/or a SharePoint application).

In cases, the data warehouse 130 may be configured to extract issue tickets from the ticket database 120. The issue tickets may be extracted on a periodic basis. For example, the issue tickets may be extracted hourly, daily, weekly, monthly, and the like. In one example, the data warehouse 130 may be configured to send the issue tickets to the client service 140. In another example, the client service 140 may pull the ticket data from the data warehouse 120. The client service 140 may be configured to format the ticket data for processing via the cognitive services 150. In one example, the client service 140 may format the ticket data to JSON. When the ticket data is formatted to JSON, the client service 140 may send the formatted data to the cognitive services 150. In one example, the cognitive services 150 may be configured to categorize the ticket data. In one example, the cognitive services 150 may include a collection of integrated cloud services to build, deploy, and manage applications such as Azure. For example, the cognitive services 150 may include a text analytics Application Programming Interface (API). In one example, the ticket data is categorized using a machine learning text classifier. The machine learning text classifier may include any machine learning text classifier for categorizing and/or classifying text data as known by a person having ordinary skill in the art. The ticket data (e.g., the submitted issues data) may be categorized into issue topic categories. In this regard, a topic associated with the ticket data (e.g., each submitted issue) may be identified. When the topic associated with a submitted issue is identified, the ticket data (e.g., for each submitted issue) may be allocated to an issue topic category based on the identified topic. In some examples, the issue topic categories including the ticket data allocated to each issue topic category is sent to the client service 140. The client service 140 may send the issue topic categories including the ticket data allocated to each issue topic category to the data warehouse 130 for storage and/or processing.

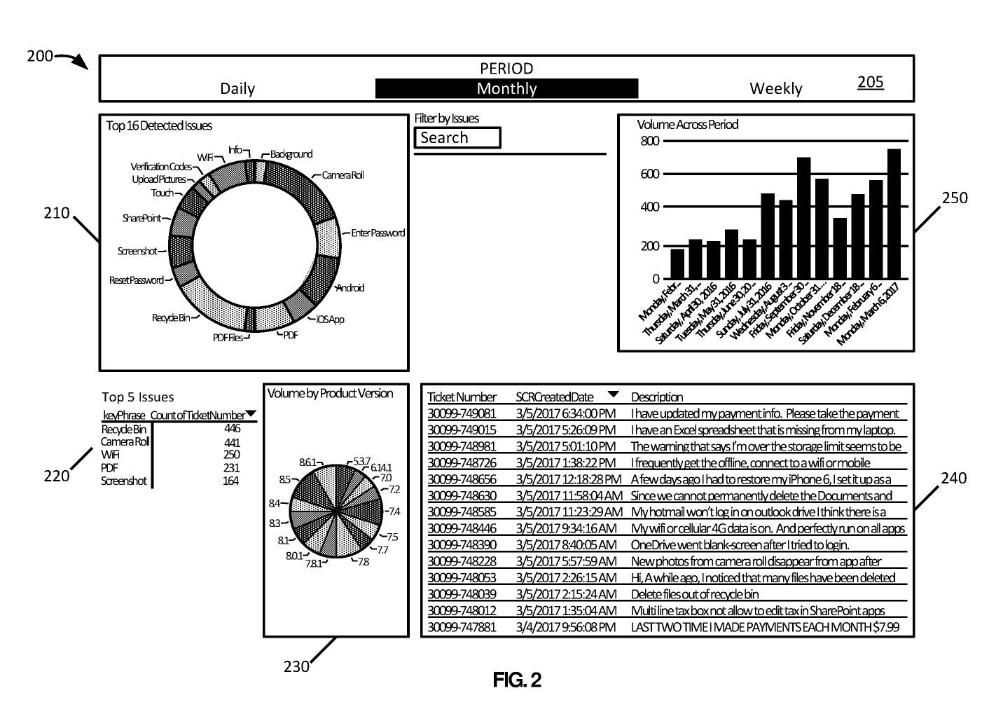

In some examples, the data warehouse 130 is configured to process the received issues data categorized by issue topics. For example, the data warehouse 130 may generate an active summary of the submitted issues data for presentation in a control panel. In one example, the control panel may facilitate viewing of the active summary. In another example, the control panel may facilitate viewing, manipulating, and/or interacting with the submitted issues data and/or the active summary. In one example, the active summary of the submitted issues data includes at least one of issue topic categories, a time scale associated with the issue topic categories, one or more submitted issue tickets, product version data, and one or more top issue topic categories. The issue topic categories may include categories of issue data associated with the service 160, which will be described in more detail relative to FIG. 2. The time scale associated with the issue topic categories may include an hourly, daily, weekly, and/or monthly representation of the frequency (e.g., a number) of submitted issues (e.g., issue tickets) associated with a topic category. The one or more submitted issue tickets may include submitted issue tickets for a topic category and the corresponding issue (e.g., the text of the issue that is submitted). The product version data may include the frequency (e.g., a number and/or percentage) of submitted issues (e.g., issue tickets) associated with a product version. In one example, the product version is the version of a client application associated with the service 160. In another example, the product version is the version of the service 160. In another example, the product version is the version of a product associated with the service 160. The one or more top issue categories may include the issue categories having the highest number of submitted issues. In one example, a list of the top issue categories and their associated number of submitted issues may be presented in the active summary.

In one example, the active summary indicates at least one issue topic category having a highest number of submitted issues within a time span. In one example, the time span includes at least one of an hour, a day, a week, and a month. In this regard, the active summary may indicate the issue topic category having the highest number of submitted issues within an hour (e.g., within an hour of the present time). In another example, the active summary may indicate the issue topic category having the highest number of submitted issues within a day. The day may include the present day and/or a past day. In another example, the active summary may indicate the issue topic category having the highest number of submitted issues within a week. The week may include the present week and/or a past week. In another example, the active summary may indicate the issue topic category having the highest number of submitted issues within a month. The month may include the present month and/or a past month. In another example, the active summary may indicate at least one issue topic category having a highest number of submitted issues (e.g., without an association to a time scale and/or time span).

In some examples, the data warehouse 130 is configured to send help content associated with the at least one issue topic category having the highest number of submitted issues (e.g., within the time span) to the service 160 for updating an in-app help pane of an application associated with the service 160 to reflect the help content. In one example, the help content may include content for helping a user/customer of the service 160 resolve the submitted issue. For example, the help content may include an article with instructions for resolving the submitted issue. In this regard, in response to receiving a selection of the help content reflected in the in-app help pane, an article with the help content may be displayed in a user interface to the application.

In one example, the help content is sent to the service 160 for updating the in-app help pane of the application associated with the service 160 to reflect the help content when help content associated with the at least one issue topic category having the highest number of submitted issues is not included in a current version of the in-app help pane. For example, a new feature of the service 160 may have one or more issues reflected by a high number of submitted issues. Help content associated with the new feature may not be included in the current version of the in-app help pane. As such, help content for the submitted issues associated with the new feature may be sent to the service 160 for updating the in-app help pane to reflect (e.g., include) the help content. In this regard, the in-app help pane is dynamically updated as one or more issues associated with the service 160 are submitted. In another example, updated help content is sent to the service 160 when the help content associated with the at least one issue topic category having the highest number of submitted issues within the time span is included in a current version of the in-app help pane. For example, help content already included in the in-app help pane may need to be updated with additional and/or new content (e.g., when additional help content associated with an issue may be helpful to resolve an issue).

In other examples, the active summary may indicate a change in the number of submitted issues associated with at least one issue topic category within the time span. In one example, the change includes a greater number of submitted issues. For example, when the time span includes two days, the change may include a greater number of submitted issues associated with the at least one issue topic category on the second day than the number of submitted issues on the first day. In one example, the change in the number of submitted issues associated with the at least one issue topic category may include a spike in the number of submitted issues within a time span. In one example, the time span includes at least one of an hour, a day, a week, and a month. In this regard, the active summary may indicate the issue topic category having a change in the number (e.g., a greater number) of submitted issues within an hour (e.g., within an hour of the present time). In another example, the active summary may indicate the issue topic category having a change in the number (e.g., a greater number) of submitted issues within a day. The day may include the present day and/or a past day. In another example, the active summary may indicate the issue topic category having a change in the number (e.g., a greater number) of submitted issues within a week. The week may include the present week and/or a past week. In another example, the active summary may indicate the issue topic category having a change in the number (e.g., a greater number) of submitted issues within a month. The month may include the present month and/or a past month.

In some examples, the data warehouse 130 is configured to send help content associated with the at least one issue topic category having a change in the number (e.g., a greater number) of submitted issues within the time span to the service 160 for updating the in-app help pane of the application associated with the service 160 to reflect the help content. In one example, the help content may include content for helping a user/customer of the service 160 resolve the submitted issue. For example, the help content may include an article with instructions for resolving the submitted issue. In this regard, in response to receiving a selection of the help content reflected in the in-app help pane, an article with the help content may be displayed in a user interface to the application.

In one example, the help content is sent to the service 160 for updating the in-app help pane of the application associated with the service 160 to reflect the help content when help content associated with the at least one issue topic category having a change in the number (e.g., a greater number) submitted issues is not included in a current version of the in-app help pane. For example, a new feature and/or product version of the service 160 may have one or more issues reflected by a high number of submitted issues. Help content associated with the new feature and/or product version may not be included in the current version of the in-app help pane. As such, help content for the submitted issues associated with the new feature may be sent to the service 160 for updating the in-app help pane to reflect (e.g., include) the help content. In this regard, the in-app help pane is dynamically updated as one or more issues associated with the service 160 are submitted. In another example, updated help content is sent to the service 160 when the help content associated with the at least one issue topic category having a change in the number (e.g., a greater number) submitted issues within the time span is included in a current version of the in-app help pane. For example, help content already included in the in-app help pane may need to be updated with additional and/or new content (e.g., when additional help content associated with an issue may be helpful to resolve an issue).

In some examples, the service 160 is configured to send help content associated with the at least one issue topic category having the highest number of submitted issues (e.g., within the time span) and/or the at least one category having a change in the number (e.g., a greater number) of submitted issues to the client computing device 104 for updating an in-app help pane of an application associated with the service 160 to reflect the help content. In one example, the service 160 is configured to send help content associated with at least one topic issue having any number of submitted issues to the client computing device 104 for updating an in-app help pane of an application associated with the service 160 to reflect the help content.

As illustrated in FIG. 1, the client computing device 104 includes user interface component 110. In some examples, the user interface component 110 may be configured to display an application for accessing and/or interacting with a dataset (e.g., a control panel as discussed herein), the application service 160, and the like. As discussed above herein, in one example, an application may include any application suitable for accessing datasets (e.g., datasets stored at the application service 160) such as collaboration applications, email applications, chat applications, voice applications, and the like. In one example, a collaboration application may include an application such as a OneDrive application and a SharePoint application. In one example, the application is displayed in the user interface via the user interface component 110 when the application is launched.

In some examples, the user interface component 110 may be configured to display the control panel including an active summary, as discussed herein. In other examples, the user interface component 110 may be configured to present the active summary in the control panel. In some examples, the user interface component 110 may be configured to display and update the in-app help pane of an application to reflect the help content. In one example, the user interface component 110 may surface the help content in a top position within the in-app help pane. In one example, the top position within the in-app help pane may include at least one of three positions within a top portion of the in-app help pane. In another example, the top position within the in-app help pane may include at least one of five positions within a top portion of the in-app help pane. In yet another example, the top position within the in-app help pane may include at least one of ten positions within a top portion of the in-app help pane.

In one example, the user interface component 110 may be a touchable user interface that is capable of receiving input via contact with a screen of the client computing device 104, thereby functioning as both an input device and an output device. For example, content may be displayed, or output, on the screen of the client computing device 104 and input may be received by contacting the screen using a stylus or by direct physical contact of a user, e.g., touching the screen. Contact may include, for instance, tapping the screen, using gestures such as swiping or pinching the screen, sketching on the screen, etc.

In another example, the user interface component 110 may be a non-touch user interface. In one case, a tablet device, for example, may be utilized as a non-touch device when it is docked at a docking station (e.g., the tablet device may include a non-touch user interface). In another case, a desktop computer may include a non-touch user interface. In this example, the non-touchable user interface may be capable of receiving input via contact with a screen of the client computing device 104, thereby functioning as both an input device and an output device. For example, content may be displayed, or output, on the screen of the client computing device 104 and input may be received by contacting the screen using a cursor, for example. In this regard, contact may include, for example, placing a cursor on the non-touchable user interface using a device such as a mouse.

Referring now to FIG. 2, an exemplary control panel 200 including submitted issues data is shown. As illustrated in FIG. 2, an active summary including the submitted issues data is presented in the control panel 200. The control panel 200 may be displayed in a user interface (e.g., via the user interface component 110) of a client computing device (e.g., such as the client computing device 104). The active summary of the submitted issues data includes issue topic categories 210, a time scale 250 associated with the issue topic categories, one or more submitted issue tickets 240, product version data 230, and one or more top issue topic categories 220. As illustrated in FIG. 2, the issue topic categories 210 include the top sixteen detected issues categorized by issue topic. For example, the issue topic categories 210, as illustrated in FIG. 2, include info, background, camera roll, enter password, Android, iOS app, PDF, PDF files, recycle bin, reset password, screenshot, SharePoint, touch, upload pictures, verification codes, and Wi-Fi. As shown in FIG. 2, the issue topic categories 210 are presented in a clear way such that an issue topic category having the highest number of submitted issues may be quickly identified.

In one example, in response to receiving a selection of at least one of the issue topic categories 210, the time scale 250 may be presented to reflect the selected issue topic category 210. In one example, the time scale 250 may be based on a time span 205. For example, the time span 205, as illustrated in FIG. 2, includes daily, weekly, and monthly time periods. In this regard, the time scale 250 may reflect a selected the time span 205. In the example illustrated in FIG. 2, the monthly time span 205 is selected. As such, the time scale 250 shows the frequency of submitted issues associated with an issue topic category 210 (e.g., a selected issue topic category 210) on a monthly basis. As such, it can be quickly identified for any given issue topic category 210 which day, week, month, and the like, an issue is submitted and/or has the highest number of submitted issues. In turn, analysis on the submitted issues may be performed and help content associated with the submitted issues may be provided in a timely manner. Additionally, when a submitted issue reflects a deficiency in a produce and/or service, the product and/or service may be quickly fixed.

In another example, in response to receiving a selection of at least one of the issue topic categories 210, the one or more submitted issue tickets 240 may be presented to reflect the selected issue topic category 210. As illustrated in FIG. 2, the one or more submitted issue tickets 240 include a description of each submitted ticket (e.g., the actual text of the submitted issue). In this regard, the submitted tickets for each issue topic category 210 may be quickly identified. In another example, the one or more submitted issue tickets 240 may be presented based on a time span 205. For example, the one or more submitted issue tickets 240 may be presented based on an hour, day, week, and/or month. In one example, when a spike in submitted issues is detected for an issue topic category 240, the submitted issue tickets may be quickly identified to determine whether the spike is indicative of the same issue with the issue topic category 240. In this regard, the issue can be quickly identified, fixed, and/or help content for resolving the issue may be provided.

As illustrated in FIG. 2, the product version data 230 may indicate the frequency of submitted issue tickets based on a product version. In this regard, a product version having a high number of submitted issue tickets may be analyzed and debugged to determine whether the product version requires an improvement and/or new or additional help content could be provided to help users resolve the issue. As such, internal processes associated with a product and/or service may be improved. In one example, the one or more top issue topic categories 220 may be included in the active summary for presentation in the control panel 200. In the example illustrated in FIG. 2, the top 5 issue topic categories 220 include recycle bin, camera roll, Wi-Fi, PDF, and screenshot. As illustrated in FIG. 2, the top 5 issue topic categories 220 include the number of submitted issues tickets associated with the top issue topic category. In this regard, the issue topic categories 210 having the highest number of submitted issue tickets may be quickly identified and remedied.

While the present disclosure discusses the control panel 200 including an active summary of the submitted issues data including issue topic categories 210, a time scale 250 associated with the issue topic categories, one or more submitted issue tickets 240, product version data 230, and one or more top issue topic categories 220, this is only exemplary and should not be considered limiting. Any number of control panels, active summaries, issue topic categories, time scales, submitted issue tickets, product version data, and top issue topic categories may be utilized in conjunction with the present disclosure.

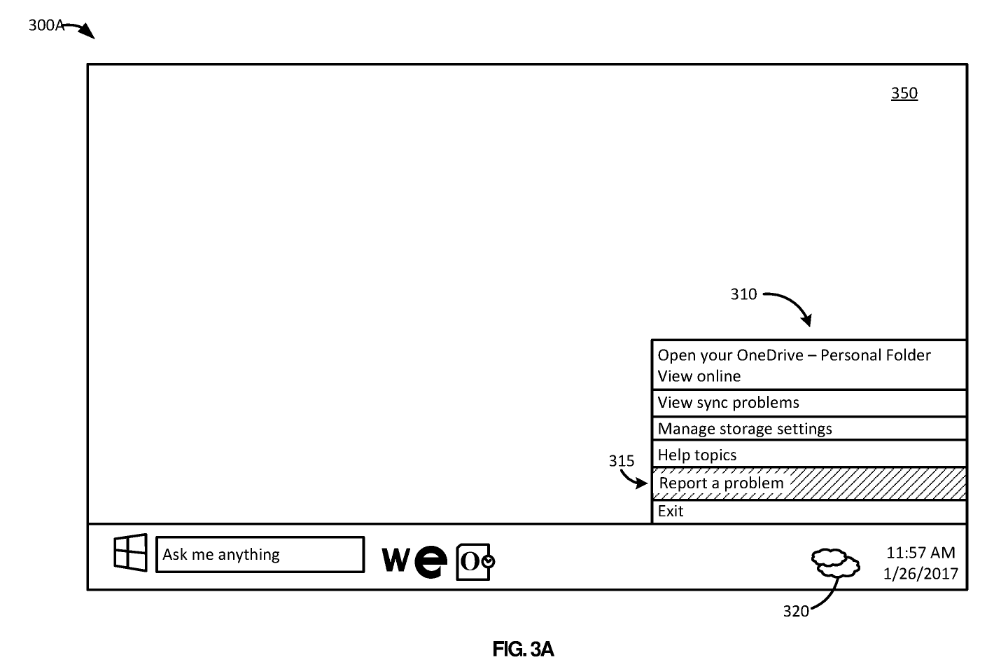

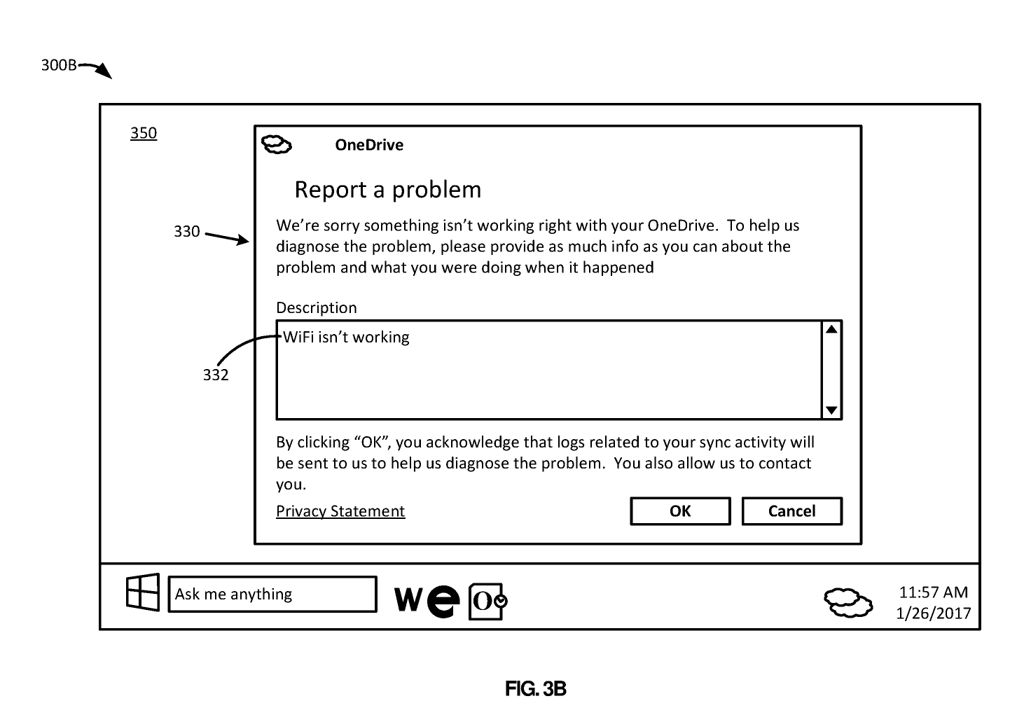

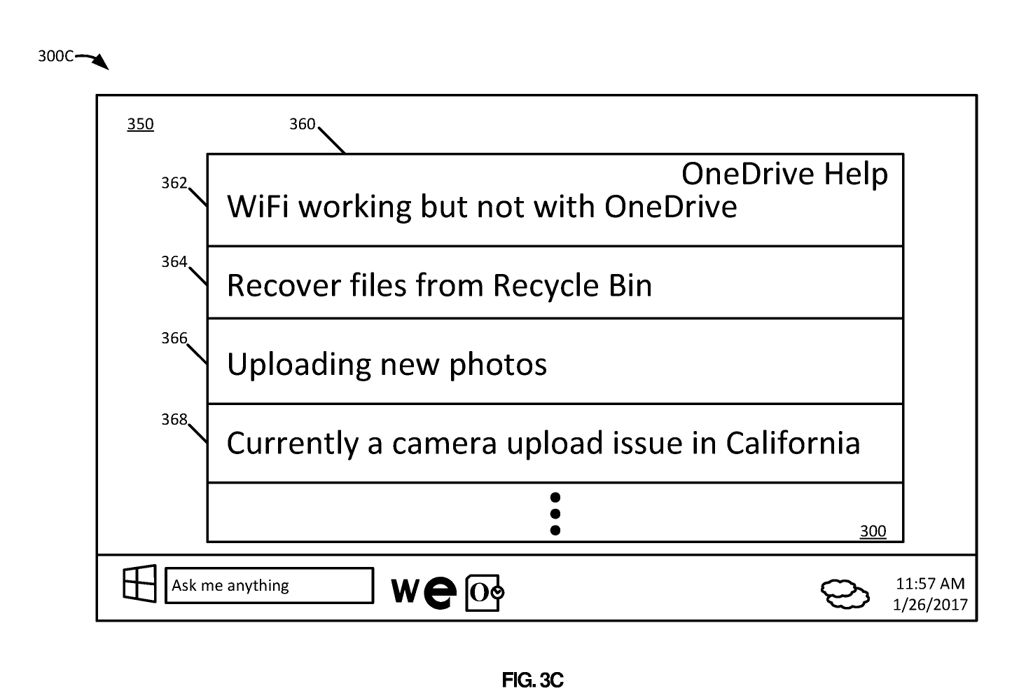

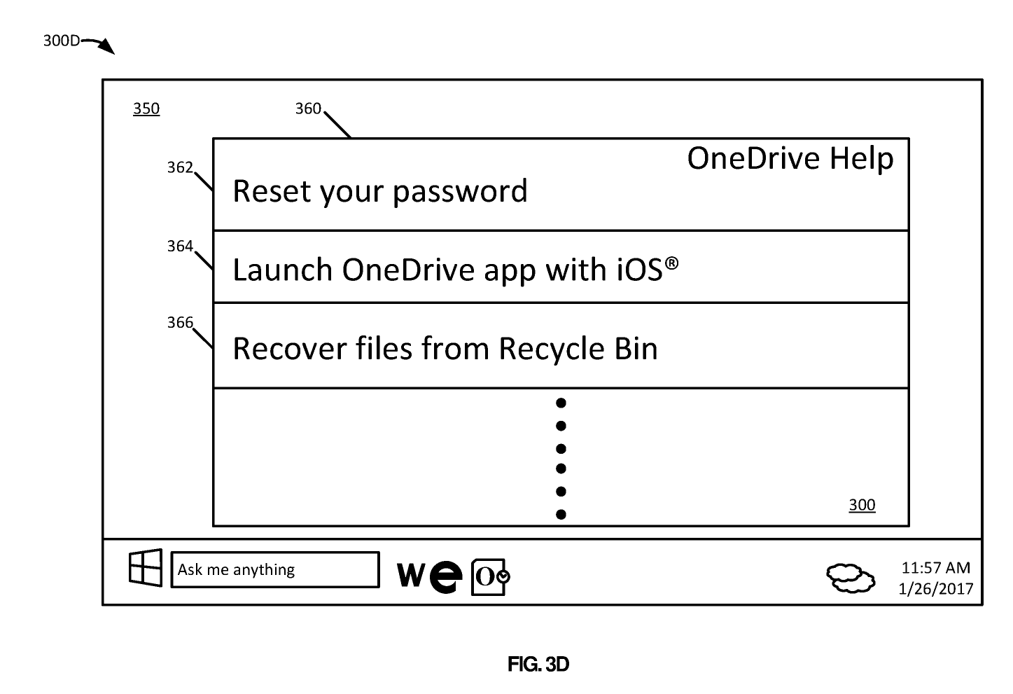

Referring now to FIG. 3A, one view 300A of an application options panel 310 displayed in a user interface 350 for reporting a problem and/or submitting an issue associated with a service is shown. As illustrated in FIG. 3A, the exemplary application options panel 310 includes a plurality of options associated with an application and/or a service. In the example illustrated in FIG. 3A, the application is a OneDrive application and the service is OneDrive. In this regard, in response to receiving a selection of a OneDrive icon 320, the application options panel 310 may be displayed in the user interface 350. As illustrated in FIG. 3A, the application options panel 310 includes a report a problem option 315. In one example, in response to receiving a selection of the report a problem option 315, an issue reporting panel may be displayed in the user interface 350.

With reference now to FIG. 3B, one view 300B of an issue reporting panel 330 displayed in the user interface 350 for reporting a problem and/or submitting an issue associated with a service is shown. As illustrated in FIG. 3B, the service is OneDrive. The issue reporting panel 330 includes a description box 332 for entering a description of an issue associated with the service. In the example illustrated in FIG. 3B, the issue includes, “WiFi isn't working.” In one example, in response to receiving a selection of the OK button included in the issue reporting panel 330, the issue is submitted and an issue ticket is created and stored in the ticket database 120, as described herein. In this regard, the issue will be included in the submitted issues data categorized by issue topics as described herein. In this example, the issue would be included in the issue topic category, “Wi-Fi”.

FIG. 3C illustrates one view 300C in a progression of views of an application 300 displayed in the user interface 350 for displaying an in-app help pane 360. As illustrated in FIG. 3C, the exemplary application 300 is a OneDrive application. In this regard, in response to receiving a selection of an option within the application 300 for displaying in-app help, the in-app help pane 360 may be displayed within the application 300. The in-app help pane 360 includes help content for issue topics associated with the service (e.g., OneDrive). For example, as illustrated in FIG. 3C, a first position 362 (e.g., a top position) within the in-app help pane 360 includes help content “WiFi working but not with OneDrive.” In this regard, a user who is having an issue with Wi-Fi not working with OneDrive may quickly identify the help content in the first position 362 of the in-app help pane 360. In one example, in response to receiving a selection of the help content in the first position 362, an article including help content related to why Wi-Fi might not be working with OneDrive may be displayed.

In one example, the help content “WiFi working but not with OneDrive” may be displayed in the first position 362 when the issue topic category having the highest number of submitted issues within a time span is Wi-Fi. In another example, help content “WiFi working but not with OneDrive” may be displayed in the first position 362 when the issue topic category having a change in the number of submitted issues (e.g., a spike is detected) within a time span is Wi-Fi. In one example, as illustrated in FIG. 3C, a second position 364 (e.g., a top position) within the in-app help pane 360 includes help content “Recover files from recycle bin.” In this regard, a user who is having an issue with finding files from the recycle bin may quickly identify the help content in the second position 364 of the in-app help pane 360. In one example, in response to receiving a selection of the help content in the second position 364, an article including help content related to recovering files from the recycle bin may be displayed.

In one example, the help content “Recover files from recycle bin” may be displayed in the second position 364 when the issue topic category having the highest number of submitted issues within a time span is recycle bin. In another example, help content “Recover files from recycle bin” may be displayed in the second position 364 when the issue topic category having a change in the number of submitted issues (e.g., a spike is detected) within a time span is recycle bin. In another example, as illustrated in FIG. 3C, a third position 366 (e.g., a top position) within the in-app help pane 360 includes help content “Uploading new photos.” In this regard, a user who is having an issue with uploading photos (e.g., to OneDrive) may quickly identify the help content in the third position 366 of the in-app help pane 360. In one example, in response to receiving a selection of the help content in the third position 366, an article including help content related to uploading photos may be displayed.

In one example, the help content “Uploading photos” may be displayed in the third position 366 when the issue topic category having the highest number of submitted issues within a time span is Upload pictures. In another example, help content “Uploading new photos” may be displayed in the third position 366 when the issue topic category having a change in the number of submitted issues (e.g., a spike is detected) within a time span is Upload pictures. In another example, as illustrated in FIG. 3C, a fourth position 368 (e.g., a top position) within the in-app help pane 360 includes help content “Currently a camera upload issue in California.” In this regard, a user located in California who is having an issue with their camera may quickly identify the help content in the fourth position 368 of the in-app help pane 360. In one example, in response to receiving a selection of the help content in the second position 368, an article including help content related to camera roll uploading may be displayed.

In one example, the help content “Currently a camera upload issue in California” may be displayed in the fourth position 368 when the issue topic category having the highest number of submitted issues within a time span is Camera roll. In another example, help content “Currently a camera upload issue in California” may be displayed in the fourth position 368 when the issue topic category having a change in the number of submitted issues (e.g., a spike is detected) within a time span is Camera roll. In one example, the in-app help pane 360 is a first version of the in-app help pane. While FIG. 3C discusses specific examples of help content displayed and/or surfaced in various positions within the in-app help pane 360, these examples are exemplary only and should not be considered limiting.

FIG. 3D illustrates another view 300D in a progression of views of the application 300 displayed in the user interface 350 for displaying the in-app help pane 360. As illustrated in FIG. 3D, the exemplary application 300 is a OneDrive application. As discussed above, the in-app help pane 360 includes help content for issue topics associated with the service (e.g., OneDrive). In one example, the in-app help pane 360 is a second version of the in-app help pane 360. For example, in response to receiving help content associated with at least one of the issue topics (e.g., an issue topic having a highest number of submitted issues) the in-app help pane 360 may be updated to reflect the received help content (e.g., creating a second version of the in-app help pane 360). For example, as illustrated in FIG. 3D, when new help content is received, the first position 362 (e.g., a top position) within the in-app help pane 360 includes help content “Reset your password.” In this regard, a user who is having an issue with resetting her password may quickly identify the help content in the first position 362 of the in-app help pane 360. In one example, in response to receiving a selection of the help content in the first position 362, an article including help content related to resetting your password may be displayed.

In one example, the help content “Reset your password” may be displayed in the first position 362 when the issue topic category having the highest number of submitted issues within a time span is Reset Password. In another example, help content “Reset your password” may be displayed in the first position 362 when the issue topic category having a change in the number of submitted issues (e.g., a spike is detected) within a time span is Reset Password. In this regard, the in-app help pane 360 is dynamically updated to reflect the help content associated with recently submitted issues.

In another example, as illustrated in FIG. 3D, when new help content is received, the second position 364 (e.g., a top position) within the in-app help pane 360 includes help content “Launch OneDrive app with iOS®.” In this regard, a user who is having an issue with launching a OneDrive app with an iOS® device and/or wants to learn how to launch a OneDrive app with an iOS® device may quickly identify the help content in the second position 364 of the in-app help pane 360. In one example, in response to receiving a selection of the help content in the second position 364, an article including help content related to launching a OneDrive app with an iOS® device may be displayed.

In one example, the help content “Launch OneDrive app with iOS®” may be displayed in the second position 364 when the issue topic category having the highest number of submitted issues within a time span is iOS® App. In another example, help content “Launch OneDrive app with iOS®” may be displayed in the second position 364 when the issue topic category having a change in the number of submitted issues (e.g., a spike is detected) within a time span is iOS® App. In this regard, the in-app help pane 360 is dynamically updated to reflect the help content associated with recently submitted issues.

As illustrated in FIG. 3D, the help content “Recover files from recycle bin” is displayed in the third position 366 of the in-app help pane 360. In one example, the help content “Recover files from recycle bin” is moved from the second position 364 in the first version of the in-app help pane 360 to the third position 366 in the second version of the in-app help pane 360 when updated help content “Recover files from recycle bin” is received for surfacing in the in-app help pane. For example, an article including the help content may be updated to include additional help content. While FIG. 3D discusses specific examples of help content displayed and/or surfaced in various positions within the second version of the in-app help pane 360, these examples are exemplary only and should not be considered limiting.

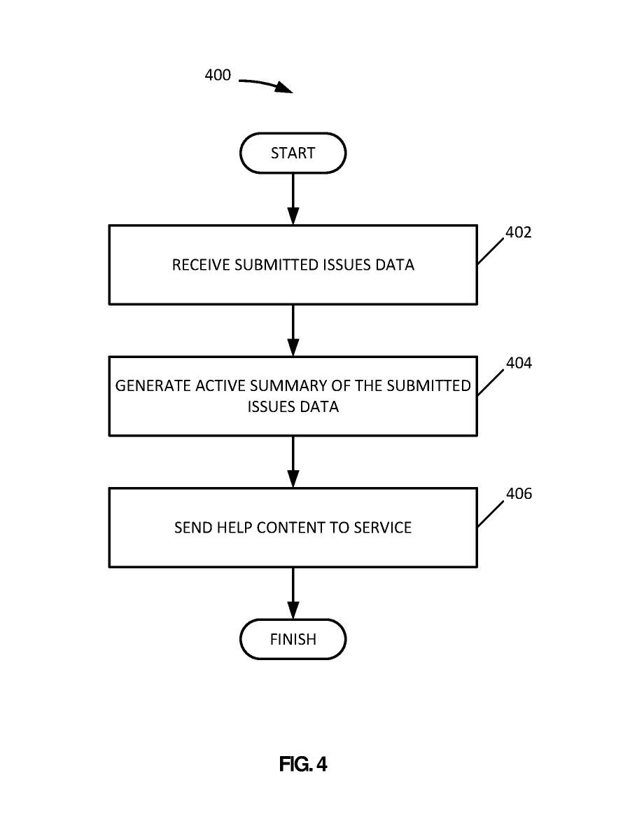

Referring now to FIG. 4, an exemplary method 400 for dynamically updating in-app help to reflect help content associated with submitted issues, according to an example aspect is shown. Method 400 may be implemented on a computing device or a similar electronic device capable of executing instructions through at least one processor. Method 400 may begin at operation 402, where submitted issues data categorized by issue topics associated with a service is received. The submitted issues data may be processed by cognitive services, such as Azure, by applying a machine learning text classifier to the data. The processed data may be categorized by issue topics associated with the service. For example, a plurality of categories of issue topics may be created for the service. In one example, the plurality of categories of issues topics may include topics such as info, background, camera roll, enter password, Android, iOS app, PDF, PDF files, recycle bin, reset password, screenshot, SharePoint, touch, upload pictures, verification codes, and Wi-Fi. In one example, the service 160 may be a cloud storage service such as OneDrive, SharePoint, and the like.

When submitted issues data categorized by issue topics associated with a service is received, flow proceeds to operation 404 where an active summary of the submitted issues data is generated for presentation in a control panel. In one example, the control panel may facilitate viewing of the active summary. In another example, the control panel may facilitate viewing, manipulating, and/or interacting with the submitted issues data and/or the active summary. In one example, the active summary of the submitted issues data includes at least one of issue topic categories, a time scale associated with the issue topic categories, one or more submitted issue tickets, product version data, and one or more top issue topic categories. In one example, the active summary indicates at least one issue topic category having a spike in submitted issues within a time span. In another example, the active summary indicates at least one issue topic category having a highest number of submitted issues within a time span. In another example, the active summary indicates a change in a number of submitted issues associated with at least one issue topic category within the time span. In one example, the change includes a greater number of submitted issues.

When an active summary of the submitted issues data is generated for presentation in a control panel, flow proceeds to operation 406 where help content associated with the at least one issue topic category having the spike in submitted issues within the time span is sent to the service for updating an in-app help pane of an application associated with the service to reflect the help content. In one example, the in-app help pane is updated to reflect the help content by surfacing the help content in a top position within the in-app help pane. In one example, the help content is sent to the service for updating the in-app help pane of the application associated with the service to reflect the help content when help content associated with the at least one issue topic category having the spike in submitted issues is not included in a current version of the in-app help pane. In another example, updated help content is sent to the service when the help content associated with the at least one issue topic category having the spike in submitted issues within the time span is included in a current version of the in-app help pane.

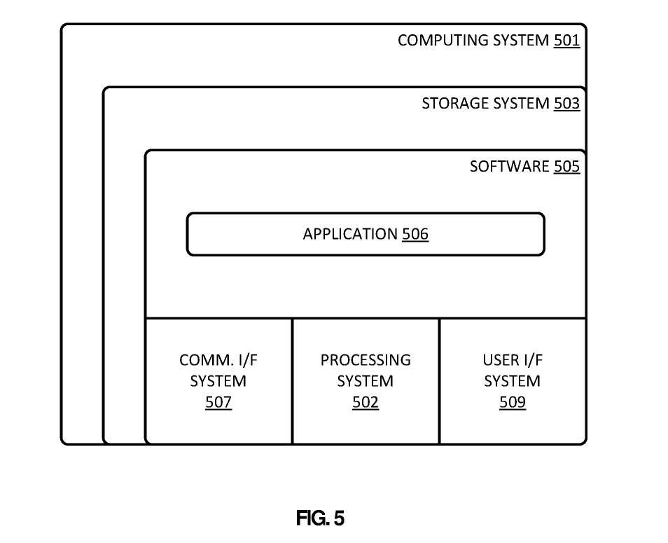

FIG. 5 illustrates computing system 501 that is representative of any system or collection of systems in which the various applications, services, scenarios, and processes disclosed herein may be implemented. Examples of computing system 501 include, but are not limited to, server computers, rack servers, web servers, cloud computing platforms, and data center equipment, as well as any other type of physical or virtual server machine, container, and any variation or combination thereof. Other examples may include smart phones, laptop computers, tablet computers, desktop computers, hybrid computers, gaming machines, virtual reality devices, smart televisions, smart watches and other wearable devices, as well as any variation or combination thereof.

Computing system 501 may be implemented as a single apparatus, system, or device or may be implemented in a distributed manner as multiple apparatuses, systems, or devices. Computing system 501 includes, but is not limited to, processing system 502, storage system 503, software 505, communication interface system 507, and user interface system 509. Processing system 502 is operatively coupled with storage system 503, communication interface system 507, and user interface system 509.

Processing system 502 loads and executes software 505 from storage system 503. Software 505 includes application 506, which is representative of the applications discussed with respect to the preceding FIGS. 1-4, including the in-app help described herein. When executed by processing system 502 to enhance support feedback systems, software 505 directs processing system 502 to operate as described herein for at least the various processes, operational scenarios, and sequences discussed in the foregoing implementations. Computing system 501 may optionally include additional devices, features, or functionality not discussed for purposes of brevity.

Referring still to FIG. 5, processing system 502 may comprise a micro-processor and other circuitry that retrieves and executes software 505 from storage system 503. Processing system 502 may be implemented within a single processing device, but may also be distributed across multiple processing devices or sub-systems that cooperate in executing program instructions. Examples of processing system 502 include general purpose central processing units, application specific processors, and logic devices, as well as any other type of processing device, combinations, or variations thereof.

Storage system 503 may comprise any computer readable storage media readable by processing system 502 and capable of storing software 505. Storage system 503 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 503 may also include computer readable communication media over which at least some of software 505 may be communicated internally or externally. Storage system 503 may be implemented as a single storage device, but may also be implemented across multiple storage devices or sub-systems co-located or distributed relative to each other. Storage system 503 may comprise additional elements, such as a controller, capable of communicating with processing system 502 or possibly other systems.

Software 505 may be implemented in program instructions and among other functions may, when executed by processing system 502, direct processing system 502 to operate as described with respect to the various operational scenarios, sequences, and processes illustrated herein. For example, software 505 may include program instructions for implementing enhanced support feedback system.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 505 may include additional processes, programs, or components, such as operating system software, virtual machine software, or other application software, in addition to or that include application 506. Software 505 may also comprise firmware or some other form of machine-readable processing instructions executable by processing system 502.

In general, software 505 may, when loaded into processing system 502 and executed, transform a suitable apparatus, system, or device (of which computing system 501 is representative) overall from a general-purpose computing system into a special-purpose computing system customized to facilitate enhanced guided action systems. Indeed, encoding software 505 on storage system 503 may transform the physical structure of storage system 503. The specific transformation of the physical structure may depend on various factors in different implementations of this description. Examples of such factors may include, but are not limited to, the technology used to implement the storage media of storage system 503 and whether the computer-storage media are characterized as primary or secondary storage, as well as other factors.

For example, if the computer readable storage media are implemented as semiconductor-based memory, software 505 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 507 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 509 is optional and may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 509. In some cases, the input and output devices may be combined in a single device, such as a display capable of displaying images and receiving touch gestures. The aforementioned user input and output devices are well known in the art and need not be discussed at length here.

User interface system 509 may also include associated user interface software executable by processing system 502 in support of the various user input and output devices discussed above. Separately or in conjunction with each other and other hardware and software elements, the user interface software and user interface devices may support a graphical user interface, a natural user interface, or any other type of user interface.

Communication between computing system 501 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the Internet protocol (IP, IPv4, IPv6, etc.), the transfer control protocol (TCP), and the user datagram protocol (UDP), as well as any other suitable communication protocol, variation, or combination thereof.

In any of the aforementioned examples in which data, content, or any other type of information is exchanged, the exchange of information may occur in accordance with any of a variety of protocols, including FTP (file transfer protocol), HTTP (hypertext transfer protocol), REST (representational state transfer), WebSocket, DOM (Document Object Model), HTML (hypertext markup language), CSS (cascading style sheets), HTML5, XML (extensible markup language), JavaScript, JSON (JavaScript Object Notation), and AJAX (Asynchronous JavaScript and XML), as well as any other suitable protocol, variation, or combination thereof.

Among other examples, the present disclosure presents systems comprising: one or more computer readable storage media; and program instructions stored on the one or more computer readable storage media that, when executed by at least one processor, cause the at least one processor to at least: receive submitted issues data categorized by issue topics associated with a service; generate an active summary of the submitted issues data for presentation in a control panel, wherein the active summary indicates at least one issue topic category having a highest number of submitted issues within a time span; and send help content associated with the at least one issue topic category having the highest number of submitted issues within the time span to the service for updating an in-app help pane of an application associated with the service to reflect the help content. In further examples, the help content is sent to the service for updating the in-app help pane of the application associated with the service to reflect the help content when help content associated with the at least one issue topic category having the highest number of submitted issues within the time span is not included in a current version of the in-app help pane. In further examples, the active summary of the submitted issues data includes at least one of issue topic categories, a time scale associated with the issue topic categories, one or more submitted issue tickets, product version data, and one or more top issue topic categories. In further examples, the time span includes at least one of an hour, a day, a week, and a month. In further examples, the submitted issues data is categorized by issue topics using a machine learning text classifier. In further examples, the in-app help pane is updated to reflect the help content by surfacing the help content in a top position within the in-app help pane. In further examples, the program instructions, when executed by the at least one processor, further cause the at least one processor to send updated help content when the help content associated with the at least one issue topic category having the highest number of submitted issues within the time span is included in a current version of the in-app help pane. In further examples, the active summary indicates a change in a number of submitted issues associated with at least one issue topic category within the time span, and wherein the change includes a greater number of submitted issues. In further examples, the program instructions, when executed by the at least one processor, further cause the at least one processor to send help content associated with the at least one issue topic category having a greater number of submitted issues within the time span to the service for updating the in-app help pane of the application associated with the service to reflect the help content. In further examples, the in-app help pane is updated to reflect the help content by surfacing the help content in a top position within the in-app help pane.

Further aspects disclosed herein provide an exemplary computer-implemented method for dynamically updating in-app help to reflect help content associated with submitted issues, the method comprising: receiving submitted issues data categorized by issue topics associated with a service; generating an active summary of the submitted issues data for presentation in a control panel, wherein the active summary indicates at least one issue topic category having a spike in submitted issues within a time span; and sending help content associated with the at least one issue topic category having the spike in submitted issues within the time span to the service for updating an in-app help pane of an application associated with the service to reflect the help content. In further examples, the active summary of the submitted issues data includes at least one of issue topic categories, a time scale associated with the issue topic categories, one or more submitted issue tickets, product version data, and one or more top issue topic categories. In further examples, the time span includes at least one of an hour, a day, a week, and a month. In further examples, the in-app help pane is updated to reflect the help content by surfacing the help content in a top position within the in-app help pane. In further examples, the active summary indicates at least one issue topic category having a highest number of submitted issues within the time span.

Additional aspects disclosed herein provide an exemplary computing apparatus comprising: one or more computer readable storage media; and an application associated with a service embodied at least in part in program instructions stored on the one or more computer readable storage media and comprising: an issue reporting panel through which to submit an issue associated with the service; a first version of an in-app help pane through which to display help content for issue topics associated with the service in a user interface to the application; and a second version of the in-app help pane through which to, in response to receiving help content associated with at least one of the issue topics having a highest number of submitted issues within a time span, display the help content in the user interface to the application, where an active summary of issue topic categories indicates the issue topics having the highest number of submitted issues within the time span. In further examples, the application associated with the service further comprises a third version of the in-app help pane through which to, in response to receiving help content associated with at least one of the issue topics having a change in a number of submitted issues associated with the at least one issue topic within a time span, where the change includes a greater number of submitted issues, display the help content in the user interface to the application, where the active summary of issue topic categories indicates the issue topics having a greater number of submitted issues within the time span. In further examples, the second version of the in-app help pane displays the help content by surfacing the help content in a top position within the second version of the in-app help pane, and wherein the third version of the in-app help pane displays the help content by surfacing the help content in a top position within the third version of the in-app help pane. In further examples, the top position within the second version of the in-app help pane and the third version of the in-app help pane includes at least one of three positions within a top portion of the in-app help pane. In further examples, the application is at least one of a mobile application, a sync client, and a web application.

Techniques for dynamically updating in-app help to reflect help content associated with submitted issues are described. Although aspects are described in language specific to structural features and/or methodological acts, it is to be understood that the aspects defined in the appended claims are not necessarily limited to the specific features or acts described above. Rather, the specific features and acts are disclosed as example forms of implementing the claimed aspects.

A number of methods may be implemented to perform the techniques discussed herein. Aspects of the methods may be implemented in hardware, firmware, or software, or a combination thereof. The methods are shown as a set of blocks that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods may be implemented via interaction between various entities discussed above with reference to the touchable user interface.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an aspect with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

Additionally, while the aspects may be described in the general context of support feedback tools that execute in conjunction with an application that runs on an operating system on a computing device, those skilled in the art will recognize that aspects may also be implemented in combination with other program modules. In further aspects, the aspects disclosed herein may be implemented in hardware.

Generally, program modules include routines, programs, components, data structures, and other types of structures that perform particular tasks or implement particular abstract data types. Moreover, those skilled in the art will appreciate that aspects may be practiced with other computer system configurations, including hand-held devices, multiprocessor systems, microprocessor-based or programmable consumer electronics, minicomputers, mainframe computers, and comparable computing devices. Aspects may also be practiced in distributed computing environments where tasks are performed by remote processing devices that are linked through a communications network. In a distributed computing environment, program modules may be located in both local and remote memory storage devices.

Aspects may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or compact servers, an application executed on a single computing device, and comparable systems.

What is claimed is:

1. A system comprising:
one or more computer readable storage media; and
program instructions stored on the one or more computer readable storage media that, when executed by at least one processor, cause the at least one processor to at least:
receive submitted issues data categorized by issue topics associated with a service;
generate an active summary of the submitted issues data for presentation in a control panel, wherein the active summary indicates at least one issue topic category having a highest number of submitted issues within a time span; and
send help content associated with the at least one issue topic category having the highest number of submitted issues within the time span to the service for updating an in-app help pane of an application associated with the service to reflect the help content.

2. The system of claim 1, wherein the help content is sent to the service for updating the in-app help pane of the application associated with the service to reflect the help content when help content associated with the at least one issue topic category having the highest number of submitted issues within the time span is not included in a current version of the in-app help pane.

3. The system of claim 1, wherein the active summary of the submitted issues data includes at least one of issue topic categories, a time scale associated with the issue topic categories, one or more submitted issue tickets, product version data, and one or more top issue topic categories.

4. The system of claim 1, wherein the time span includes at least one of an hour, a day, a week, and a month.

5. The system of claim 1, wherein the submitted issues data is categorized by issue topics using a machine learning text classifier.

6. The system of claim 1, wherein the in-app help pane is updated to reflect the help content by surfacing the help content in a top position within the in-app help pane.

7. The system of claim 1, wherein the program instructions, when executed by the at least one processor, further cause the at least one processor to send updated help content when the help content associated with the at least one issue topic category having the highest number of submitted issues within the time span is included in a current version of the in-app help pane.

8. The system of claim 1, wherein the active summary indicates a change in a number of submitted issues associated with at least one issue topic category within the time span, and wherein the change includes a greater number of submitted issues.

9. The system of claim 8, wherein the program instructions, when executed by the at least one processor, further cause the at least one processor to send help content associated with the at least one issue topic category having a greater number of submitted issues within the time span to the service for updating the in-app help pane of the application associated with the service to reflect the help content.

10. The system of claim 9, wherein the in-app help pane is updated to reflect the help content by surfacing the help content in a top position within the in-app help pane.

11. A computer-implemented method for dynamically updating in-app help to reflect help content associated with submitted issues, the method comprising:
receiving submitted issues data categorized by issue topics associated with a service;
generating an active summary of the submitted issues data for presentation in a control panel, wherein the active summary indicates at least one issue topic category having a spike in submitted issues within a time span; and
sending help content associated with the at least one issue topic category having the spike in submitted issues within the time span to the service for updating an in-app help pane of an application associated with the service to reflect the help content.

12. The computer-implemented method of claim 11, wherein the active summary of the submitted issues data includes at least one of issue topic categories, a time scale associated with the issue topic categories, one or more submitted issue tickets, product version data, and one or more top issue topic categories.

13. The computer-implemented method of claim 11, wherein the time span includes at least one of an hour, a day, a week, and a month.

14. The computer-implemented method of claim 11, wherein the in-app help pane is updated to reflect the help content by surfacing the help content in a top position within the in-app help pane.

15. The computer-implemented method of claim 11, wherein the active summary indicates at least one issue topic category having a highest number of submitted issues within the time span.

16. A computing apparatus comprising:
one or more computer readable storage media; and
an application associated with a service embodied at least in part in program instructions stored on the one or more computer readable storage media and comprising:
an issue reporting panel through which to submit an issue associated with the service;
a first version of an in-app help pane through which to display help content for issue topics associated with the service in a user interface to the application; and
a second version of the in-app help pane through which to, in response to receiving help content associated with at least one of the issue topics having a highest number of submitted issues within a time span, display the help content in the user interface to the application, where an active summary of issue topic categories indicates the issue topics having the highest number of submitted issues within the time span.

17. The computing apparatus of claim 16, wherein the application associated with the service further comprises a third version of the in-app help pane through which to, in response to receiving help content associated with at least one of the issue topics having a change in a number of submitted issues associated with the at least one issue topic within a time span, where the change includes a greater number of submitted issues, display the help content in the user interface to the application, where the active summary of issue topic categories indicates the issue topics having a greater number of submitted issues within the time span.

18. The computing apparatus of claim 17, wherein the second version of the in-app help pane displays the help content by surfacing the help content in a top position within the second version of the in-app help pane, and wherein the third version of the in-app help pane displays the help content by surfacing the help content in a top position within the third version of the in-app help pane.

19. The computing apparatus of claim 18, wherein the top position within the second version of the in-app help pane and the third version of the in-app help pane includes at least one of three positions within a top portion of the in-app help pane.

20. The system of claim 16, wherein the application is at least one of a mobile application, a sync client, and a web application.
